(19) United States
(12) Patent Application Publication
(10) Pub. No.: US 2025/0057091 A1
(43) Pub. Date: Feb. 20, 2025

(54) OXIGEN ENRICHED HORTICULTURAL CARE ENCLOSURE SYSTEM AND METHODS

(71) Applicant: Modern Day Hippy, LLC, Chandler, AZ (US)

(72) Inventor: Matthew Unger, Chandler, AZ (US)

(73) Assignee: Modern Day Hippy, LLC, Chandler, AZ (US)

(21) Appl. No.: 18/750,333

(22) Filed: Jun. 21, 2024

Related U.S. Application Data
(63) Continuation-in-part of application No. 18/235,305, filed on Aug. 17, 2023, now abandoned.
(63) Continuation-in-part of application No. 18/473,222, filed on Sep. 23, 2023.

(51) Int. Cl. A01G 9/24; A01G 9/14

(52) U.S. Cl. CPC A01G 9/247; A01G 9/14; A01G 9/246; A01G 2031/006

(57) ABSTRACT

A system and a plant care enclosure and method of using the system and enclosure to create a plurality of oxygen enriched high kinetic energy liquid streams, a highly oxygenated microbubble mist, and oxygen enriched reservoir water.

### FIELD OF THE INVENTION

The present inventions relate to aeroponic horticultural growing systems and methods of using the system to create a highly oxygenated microbubble mist and an oxygen enriched reservoir water within the enclosure.

### SUMMARY OF EMBODIMENTS

Aspects of the inventions disclosed herein may be used together or incorporated in an aeroponic growing enclosure, apparatus, or device or certain of the components may be used separately from the other components and adapted to alternate plant care devices or trimming devices. Accordingly, the inventions disclosed should not be limited to specific embodiments disclosed herein.

The system and enclosure may be incorporated in a method of creating a plant care environment, that includes providing an enclosure comprised of top wall, a side wall, and a bottom wall, that surround a tubular shaped root-growth zone, the top wall with a pot aperture above the tubular shaped root-growth zone. In use, a reservoir within the enclosure is fillable with water and water from the reservoir is pulled into a drain beneath the reservoir though a dispersion baffle that has an interior surface and a perimeter surface wherein the drain is positioned beneath the dispersion baffle interior surface and water is pulled through a plurality of dispersion baffle vents distributed equally around the dispersion baffle outer perimeter surface. Water from the drain is pumped from the reservoir into a spray-hoop that has an outer perimeter with plurality of orifices distributed substantially evenly around the outer perimeter, and wherein the spray-hoop encircles the tubular shaped root-growth zone with the outer perimeter within about six inches from the side wall. The plurality of orifices output a plurality of high kinetic energy liquid streams that impact against the side wall and shatter into a range of water mist and droplet sizes that includes a micrometer and smaller sized droplet diameters and larger water droplet diameters wherein the micrometer and smaller sized droplet diameters are temporarily suspended in the enclosure longer relative to larger water droplet diameters that fall into the reservoir. The water in the reservoir is rapidly recirculated to create a plurality of oxygen enriched high kinetic energy liquid streams, a highly oxygenated microbubble mist, and oxygen enriched reservoir water.

Numerous advantages and features of the present invention will become readily apparent from the following detailed description of the invention and the embodiments thereof, from the claims and from the accompanying drawings.

### BRIEF DESCRIPTION OF THE DRAWINGS

FIG. 1 illustrates a system block diagram of a first embodiment with an enclosure 20 functionally coupled to a Vapor Refrigeration Compression System 44 (VRCS 44) and an aeroponic droplet or mist production system positioned within the enclosure 20.

FIGS. 2A and 2B illustrate top and bottom views of a tabletop 52 that is usable separately from or with the enclosure 20.

FIG. 2C illustrates a side view of the tabletop 52 embodiment wherein a netpot 522 with a plant therein is received within the tabletop pot aperture 58 and a rotatable ring 59 enables relative rotation of the tabletop 52 and a second surface on which the rotatable ring 59 may be positioned.

FIG. 3A illustrates a perspective view of an embodiment wherein the top wall 26 of the enclosure 20 is coupled to the enclosure side wall 24 with lift arms 27 that enable the top wall 26 and tabletop 52 thereon to be raised from, and lowered to, the enclosure side wall 24 to enable a user to access the interior tubular shaped root-growth zone 29 of the enclosure 20.

FIG. 3B illustrates a side view of the enclosure 20 and showing a gap between the tabletop 52 and the enclosure top wall 26.

FIG. 4 illustrates a side view of an embodiment of the enclosure 20 wherein the VRCS 44 is incorporated into the enclosure side wall 24 and the aeroponic droplet or mist production system 30 produces a plurality of high kinetic energy liquid streams from the pump 32 that is in fluid communication with a riser 331 and a spray-hoop 350 with a plurality of orifices 332 directed substantially perpendicularly to the enclosure interior side wall 24 and a flow dispersion baffle 66 deters the flow of water in the reservoir 60 towards the pump inlet 322 or drain and directs water flow laterally towards the side wall 24 to flow through vents in the dispersion baffle 66 adjacent a flow gap 664 between the dispersion baffle 66 and the side wall 24.

FIGS. 5A and 5B illustrates a side view bottom perspective view of a flow dispersion baffle 66 or baffle with a plurality of dispersion plate vents 662 and a solid interior surface that deters the flow of water in the reservoir 60 directly towards the pump inlet 322 or drain and directs water flow laterally towards the side wall 24 and into a flow gap 664 between the dispersion baffle 66 and the side wall 24.

FIG. 5C illustrates a perspective view of a circular shaped spray-hoop 350 wherein each of a plurality of orifices 332 is distributed around the perimeter of the spray-hoop 350 at substantially equal distances from adjacent orifices 332 and aimed outwardly from the perimeter.

FIG. 6 illustrates a side view of the embodiment wherein plant roots extend down into the tubular shaped root-growth zone 29 and rest and splay laterally outward across the dispersion baffle 66 in the direction of water recirculation flow and wherein the evaporator coils 222 of a VRCS 44 is incorporated into the enclosure side wall 24 and the aeroponic droplet or mist production system 30 produces a plurality of high kinetic energy liquid streams 335 from the pump 32 that is in fluid communication with a spray-hoop 350 with a plurality of orifices 332 directed substantially perpendicularly to the enclosure interior side wall 24 and a flow dispersion baffle 66 deters the flow of water in the reservoir 60 towards the pump inlet 322 or drain and directs water flow laterally towards the side wall 24 to a flow gap 664 between the dispersion baffle 66 and the side wall 24 and ultimately through vents in the dispersion baffle 66.

The objects, features and advantages of the present invention will be more readily appreciated upon reference to the following disclosure when considered in conjunction with the accompanying drawings, wherein reference numerals are used to identify the components in the various views.

### DESCRIPTION OF EMBODIMENTS

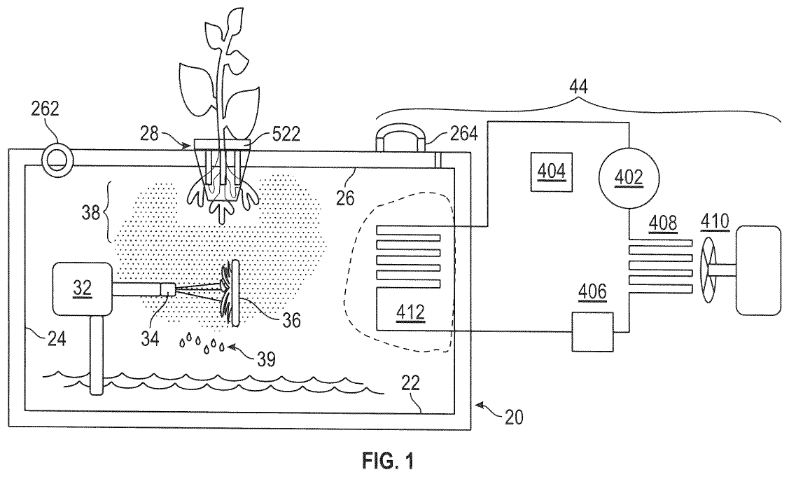

The enclosure 20 comprises a system of components and methods that provides optimal and variable growing environments for a plurality of plant species that each may be subjected to custom environmental conditions. Aspects of the invention comprise an enclosure 20 with an integrated with or coupled to a vapor refrigeration compression system 44 (VRCS 44) and an aeroponic droplet or mist production system. With reference to FIG. 1, the enclosure 20 may comprise an interior volume with an inside wall boundary, the inside wall boundary comprised of bottom wall 22, side wall 24 and top wall 26. The top wall 26 of the inside wall boundary may be removably separable from the side wall 24 and include a pot aperture 28, which in the illustrated embodiment is configured to receive a standard sized net pot 522 diameter. Moreover, the pot aperture 28 is preferably positioned above a tubular shaped root-growth zone within the interior volume bounded by the inside wall boundary and above a micro droplets 38 mist produced by the aeroponic droplet or mist production system in the tubular shaped root-growth zone.

In preferred embodiments, the enclosure 20 comprises an insulated enclosure that is integrated with and functionally coupled to VRCS 44 that is temperature controllable between about 50 degrees and 86 degrees Fahrenheit. A preferred VRCS 44 comprises a closed tubing with a refrigerant therein in functional communication with compressor 402 condenser coils 408, an expansion valve 406 and an evaporator fan 410 and evaporator coils 412 functionally coupled to the interior volume (see cutout) within the inside wall boundary of the enclosure 20. A temperature controller 404 and thermostat within the enclosure 20 is enabled to maintain the temperature within the enclosure 20 as specified and at or between desired temperatures and enables methods of controlling the cooling the enclosure 20 and tubular shaped root-growth zone 29 therein to a first temperature and ramping the temperature in the tubular shaped root-growth zone 29 to a second temperature over a time period, wherein the temperature may be held at a plurality of different temperatures over a period of time based on temperature dependent root nutrient absorption efficiency targets, or the temperature in the enclosure 20 may be cooled to the first temperature and then allowed to gradually warm to the second temperature to enable enclosure 20 temperature dwell times of at least about two hours and corresponding to said temperature dependent root nutrient absorption efficiency targets. The enclosure 20 is preferably tubular shaped, such as cylindrical or rectangular shaped, and comprised of evaporator coils and insulation sandwiched between an outside side wall 25 and an inside side wall 24 to cool the tubular shaped root-growth zone 29 and also minimize heat transfer through the side walls from outside to inside the enclosure 20 and vice versa. Further, the enclosure 20 includes a reservoir 60 filled with cooled oxygenated water that acts also acts as a thermal mass to maintain temperatures within the enclosure 20.

Liquid, such as water with plant food, may be stored in a reservoir in the enclosure 20 such that the pump 32 pumps water from the reservoir and circulates or exchanges the water, plant food or nutrients, plant probiotics, and prebiotics at a rate of at least 6-10 times per hour but may be as much as 20 times per hour and directs it through an outlet or orifice and against a kinetic impact or dispersion plate 36 oriented substantially perpendicularly to the water stream and inside the inside wall boundary. In a first preferred embodiment, water from the pump 32 is output through an outlet with sufficient kinetic energy and against the dispersion plate 36 to produce a range of range of water droplet sizes that includes macro sized and nano droplets of water. The tubular shaped root-growth zone 29 is of sufficient distance from the substantially perpendicularly oriented surface to permit the heavier water droplets to fall back to the reservoir while allowing the smaller nano droplet sized water droplets to remain suspended in the tubular shaped root-growth zone 29 and deposit on plant roots in said zone. In one embodiment, sufficient kinetic energy was obtainable with an 800 GPH (3000 L/H) 24-Watt, submersible pump 32 functionally coupled to a plurality of spray nozzles 34 capable of between about 1.5-5 GPM, each nozzle 34 directed against a substantially perpendicularly oriented surface inside the inside wall boundary. In other embodiments, sufficient kinetic energy was achieved with at least one pump 32 capable of at least about 200 GPH and at least one spray nozzle 34 capable of at least about 1 GPM directed against a substantially perpendicularly oriented surface inside the inside wall boundary.

In a first embodiment, at least one spray nozzle 34 may be used as the output or outlet orifice to increase the kinetic energy or velocity of the water output from the pump 32 functionally coupled to plurality of spray nozzles 34 to the point where the kinetic energy or force of impact of water against the substantially perpendicularly oriented surface inside the inside wall boundary creates the range of water droplet sizes described herein. Moreover, the spray nozzle 34 is purposefully selected or designed so that it produces liquid output droplets preferably between about least 5-100 microns in diameter but may produce droplets as large as 1 mm in diameter, to substantially reduce if not eliminate clogging of the nozzle 34. The spray nozzle 34 of the system substantially eliminates clogging by allowing desired particulate or suspended matter that may clog an atomizer output orifice, such as plant food, such as nutrients and minerals, to pass through the spray nozzle 34 output orifice, as well as allowing other unintended or undesired particulate matter, such as hard water minerals which ordinarily clogs atomizing nozzles, to pass through the spray nozzle 34. In all embodiments, the plant food, such as nutrients and minerals are suspended within the micro droplet mist created by the aeroponic droplet or mist production system 30 and exposed to the plant root structure whilst substantially eliminating clogging of the spray nozzle 34. The aeroponic droplet or mist production system 30 creates nano and micro droplets of about 500 μm in diameter (or less) by force of impact of the water against a substantially perpendicularly oriented surface inside the inside wall boundary, such as a impact plate 36. By aiming a high kinetic energy water source, such as one created with the pump 32 and spray nozzle 34 at and against a substantially perpendicularly oriented surface inside the inside wall boundary, the aeroponic droplet or mist production system 30 is adapted to create a range of droplet sizes, which range of droplet sizes includes a nano to micro droplet mist of droplets less than about 500 microns in diameter, and preferably between about 1 and 100 microns in diameter, that remain suspended in the air inside the tubular shaped root-growth zone 29 and deposit on plant roots, and also droplets of a larger size, or on the order of 1 mm in diameter or larger, that will drop 39 towards the reservoir within inside wall boundary. In a preferred embodiment, the substantially perpendicularly oriented surface within the inside wall boundary comprises the impact plate 36 positioned to receive the output from a spray nozzle 34 that may be positioned between the spray nozzle 34 and a side wall 24 of the enclosure 20. In another embodiment, the surface oriented substantially perpendicularly to the directed spray from the spray nozzle 34 may comprise the side wall 24 of the enclosure 20 but may also comprise (and as illustrated) as an alternative to or in addition to an intermediate surface(s) interposed between the side wall 24 and the spray nozzle 34. The impact plate 36 may further comprise a non-smooth, rough, perforated, or textured surface to enhance or further facilitate the disassembly of liquid droplets and promote the disassembly of liquid droplets from the spray nozzle 34. Additionally, in at least another preferred embodiment, the aeroponic droplet or mist production system comprises a plurality of spray nozzles 34 directed at one or more impact plates 36 to increase the production of micro droplets 38. In use, a plant selected from a seed, seedling, or leafy plant, is receivable in the pot aperture 28 and leafy plant growth may occur above the top wall 26 and roots from the plant grow from exposure to the micro-droplet mist within the root growth zone while the larger than micro droplet output 39 drops away from the tubular shaped root-growth zone 29.

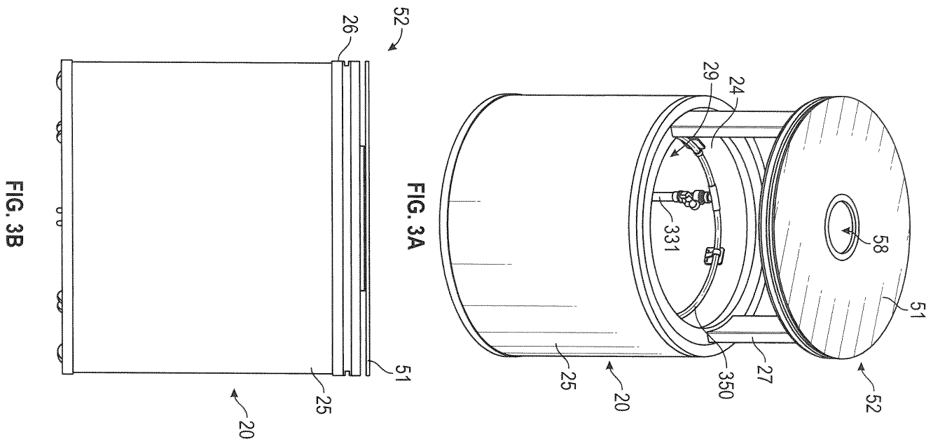

An upper cross-sectional area of the enclosure 20 wall between the outside side wall 25 and the inside side wall 24 may be devoid of evaporator coils 222 to create a warmer water vapor layer 252 in the top cross-sectional (relative to the vertical or longitudinal dimension) volume of the enclosure 20 interior relative to the lower cross-sectional volume of the enclosure 20. As one example, in one embodiment, the upper cylindrical cross-sectional area of the enclosure 20 wall between the outside side wall 25 devoid of evaporator coils comprises about the top fifth of the height of the side walls 24. A second embodiment of an enclosure 20 and components associated therewith are illustrated FIGS. 3A-6. The enclosure 20 features a height to diameter ratio of approximately 1:1 but may be between the ranges of 3:1 to 1:3. The height to diameter ratio allows for sufficient room for each of the components of the system to function as a system and to provide sufficient enclosure 20 volume for plant root growth from seedling to mature plant ready for harvesting. Insulation is included between the outside side wall 25 and the inside side wall 24 to deter heat transfer through the enclosure 20 walls and enable the VRCS 44 to efficiently maintain temperatures within the enclosure 20. Additionally, the top wall 26 of the enclosure 20 may be coupled to the enclosure side wall 24 with lift arms 27 that enable the top wall 26 and tabletop 52 thereon to be raised from, and lowered to, the enclosure side wall 24 to enable a user to access the interior tubular shaped root-growth zone 29 of the enclosure 20. The lift arms 27 may be motorized and operated by a control panel or manually powered such as by a linear gear and crank.

In preferred embodiments, the enclosure 20 volume allows room for a first portion of the plant roots, including upper portions of the tap root and root offshoots, capillaries or root hairs, growing therefrom, to be exposed to or bathed in the highly oxygenated microbubble mist 338 created by the aeroponic droplet or mist production system 30 above the reservoir water-line 62 and a second portion of the plant roots, including terminal portion of the tap root and longer root offshoots and capillaries and root hairs to extend down below the reservoir water-line 62 and be submerged in the reservoir 60. Moreover, the top volume of dense highly oxygenated microbubble mist 338 also creates a water vapor layer that provides a barrier or insulation layer and protects the lower root growth zone from drying heat that may present at the pot aperture 28 above but allows moisture in the top volume to cool and feed plant primary, secondary, and tertiary root growth in the top volume. The liquid level in the reservoir 60 fills at least about the bottom half to bottom one-third of the enclosure 20 volume below the reservoir water-line 62 in the enclosure 20 such that the liquid in the reservoir contacts the side wall 24 and inside bottom wall 22

The aeroponic droplet or mist production system 30 is comprised of a pump 32 in liquid communication with at least one output orifice and at least one substantially perpendicularly oriented surface inside the inside wall boundary, such as a side wall 24 or an impact plate 36 as illustrated, wherein the combination of the pump 32 and the at least one output orifice are capable of outputting a high-kinetic energy water stream with sufficient velocity to cause the water droplets in the water stream to fracture upon impact with the surface inside the inside wall boundary. The pump 32 and at least one output orifice produce a high-velocity or high-kinetic energy water stream that collides with the at least one substantially perpendicularly oriented surface with a sufficiently large amount of kinetic energy. The high-kinetic water stream against the surface causes the water molecules to undergo a sudden deceleration and compression whereupon the rapid change in momentum creates intense pressure and stress within the water mass, leading to its fragmentation into a range of water droplet sizes. These newly formed droplets then disperse in various directions within the tubular shaped root-growth zone 29. The size of water droplets created from the pump 32 and orifice create a range of droplets size due to fragmentation upon impact. Additionally, the properties of the substantially perpendicularly oriented surface inside the inside wall boundary, such as its texture and angle, influence droplet size by affecting the degree of deceleration and compression. In general, the resulting water droplets range from tiny mist-like water droplets of nanometer and micro diameter sizes that remain suspended within the tubular shaped root-growth zone 29 to be deposited onto the plant roots, to larger droplets that may be several millimeters in size that fall back to the reservoir. The combination of the aeroponic droplet or mist production system and VRCS 44 creates an optimal horticultural growing environment.

The high-kinetic energy liquid or water stream may be forced from at least one orifice to create a liquid stream 336 of water, or preferably a plurality of high kinetic energy liquid streams 336 are produced through a plurality of orifices 332 or holes in a pipe, tube, or hose, that extends substantially laterally around and in close proximity to, the side wall 24, such as within about ten inches or less, but preferably about two to six inches or less, from the substantially perpendicularly oriented surface inside the inside wall boundary. In one preferred embodiment, the pipe may be suspended laterally around the inner diameter of the enclosure 20 and adjacent to the inner side wall 24 by brackets. A riser 331 may be coupled between the pump 32 outlet and the pipe to raise the laterally suspended pipe to the desired height above the reservoir 60 and to the preferred elevation in the enclosure 20. Whereas a single pipe laterally oriented is preferred, the aeroponic droplet or mist production system 30 may employ a plurality of pipes positioned at alternate lateral heights within the enclosure 20 or diagonally oriented pipes relative to the vertical dimension of the enclosure 20 to vary the water fracturing atomization and droplet sizes at various heights within the tubular shaped root-growth zone 29. Moreover, the pipe may extend substantially laterally around and near the side wall 24, and the plurality of orifices 332 may be equally distributed (or each orifice 332 is spaced apart from the adjacent orifice 332 the same distance as the next or previous, respectively).

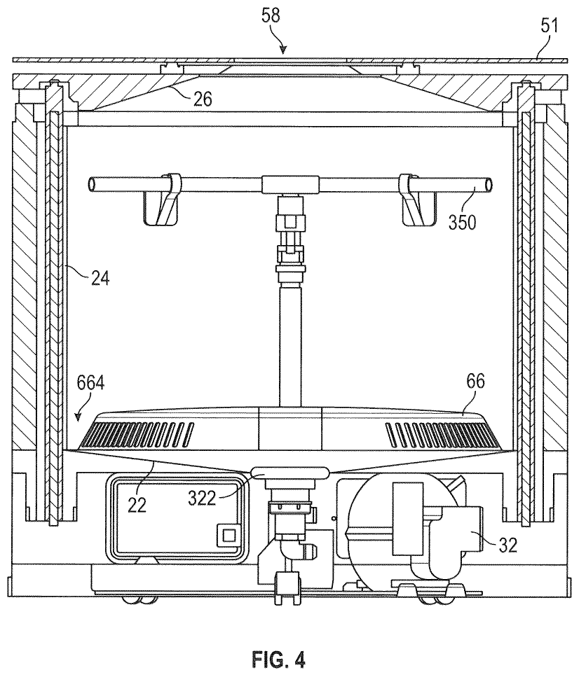

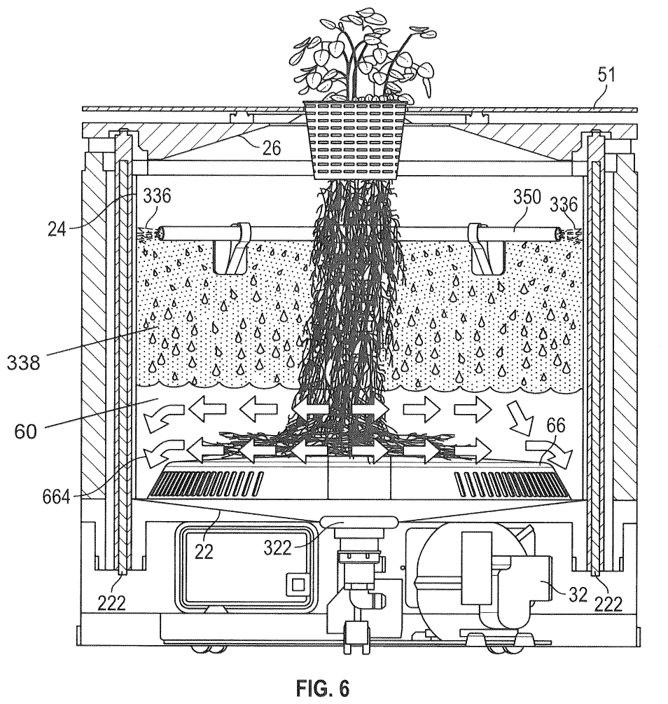

FIG. 4 illustrates a cutaway side view of an embodiment of the enclosure 20 wherein the pipe that produces the plurality of high kinetic energy liquid streams 336 comprises a spray-hoop 350 comprised of plurality of orifices 332 that are each distributed around and aimed substantially perpendicularly away from the interior perimeter of the spray-hoop 350 and at the side wall 24. In the embodiment, each of the plurality of orifices 332 produces a high kinetic energy liquid stream 336 that impacts against the side wall 24 to create a highly oxygenated microbubble mist 338. The plurality of orifices 332 create a highly oxygenated microbubble mist 338 that collectively encircles the plant roots that descend from the pot aperture 28 at and within the tubular shaped root-growth zone 29 to maximize the exposure to the highly oxygenated microbubble mist 338 while the highly oxygenated larger droplets that fall back to the reservoir 60 are drawn down and laterally to a flow gap 664 and ultimately to drain or pump inlet 322 for rapid recirculation within the system. As further illustrated in FIG. 6, in use of preferred embodiments, plant roots descend through a net pot in the pot aperture 28, vertically down through the root-growth zone 29 and roughly along the vertical and center axis of the enclosure 20, from above to below and through perimeter or diameter of the spray-hoop 350 from which the liquid streams 336 emerge to impact on the substantially perpendicularly oriented side wall 24 that fractures or atomizes the forcefully expelled water or liquid droplets. Further, in preferred embodiments, the at least one liquid output creates, or plurality of liquid outputs each create, a high kinetic energy liquid stream(s) 336 that impacts a substantially perpendicularly oriented surface inside the inside wall boundary at a flow rate sufficient to exchange or turn over all the liquid in the reservoir 60 at a minimal desired turnover or exchange rate to meet a target reservoir 60 dissolved oxygen level, and at a velocity or velocities sufficient to produce the desired fracture or atomization of the water droplets in each liquid stream 336.

In one embodiment the at least one liquid output comprises about a one-inch diameter liquid stream 336 with about 5-13 pounds per square inch (PSI), but preferably between about 8-10 PSI, to produce the fracturing or kinetic impact atomization of the liquid stream 336. In the preferred embodiment illustrated in FIG. 6, a plurality, or at about eight (8), of one-eighth-inch (⅛-inch) diameter liquid streams 336 from the spray-hoop 350 are output at between about 5-13 pounds per square inch (PSI), but preferably between about 8-10 PSI, to produce the fracturing or impact atomization of the water droplets from the liquid stream 336. Additional or alternate embodiments comprise variations of diameters of liquid streams 336 within or on a pipe 330 in an enclosure 20, or variations of enclosure 20 designs wherein a particular enclosure may have for example, four (4) one-quarter (¼-inch) diameter liquid streams 336 to produce desired fracture or impact atomization of the water droplets in the liquid stream 336. In the illustrated embodiment, the enclosure 20 and tubular shaped root-growth zone 29 therein is cylindrically shaped and has a diameter of between about 20 and 40 inches, but preferably about 30 inches, and a height of between about 20 and 40 inches, but preferably about 30 inches and a volume of between 8 and 15 cubic feet, but preferably about 12.5 cubic feet (cu ft). Additionally, while the volume of water in the reservoir 60 may be varied to adjust the barometric pressure in the enclosure 20 above and beneath the reservoir fill-level 62, the reservoir 60 will contain between about 3-15, but preferably between about 7-10, gallons of water or liquid in the reservoir 60, which volume of water will occupy the lower half to about the lower third of interior enclosure 20 volume.

The aeroponic droplet or mist production system 30 recirculates the water in the reservoir 60 rapidly to prevent stratification of the nutrients and dissolved and suspended organic matter in the reservoir 60 water and to maintain a high oxygen content of the water through all stages of the system. Because the highly oxygenated microbubble mist 338 is produced by kinetic fracturing and not atomization nozzles, the entire volume of water in the reservoir 60, including nutrients and dissolved and suspended organic matter, is exchanged at least 40 times, but preferably between about 50-60, times per hour, or about once every minute. In the illustrated embodiment, a pump 32 rated at at least 650 gallons per hour (GPH), but preferably about 800 GPH at 3 ft of head pressure, in fluid communication with a spray-hoop 350 comprised of eight (8), of one-eighth-inch (⅛-inch) diameter liquid streams 336 produced the desired fracture or atomization of the water droplets of the liquid stream 336 in the illustrated enclosure 20. The rapid recirculation rate not only maintains a high oxygen content in the system water but also produces a constant flow of the air and microdroplet mist inside the tubular shaped root-growth zone 29 as water is rapidly expelled from the plurality of orifices 332, and which air and microdroplet mist flow helps to disburse the highly oxygenated microbubble mist 338 and expose inner portions of the tap root and smaller roots to the highly oxygenated microbubble mist 338.

The aeroponic droplet or mist production system 30 disclosed herein enables a method of creating both highly oxygenated reservoir 60 water and a highly oxygenated liquid stream 336 that is both fractured or impact-atomized in part to create the highly oxygenated microbubble mist 338 and that reforms or remains in highly oxygenated larger size droplets that drop and splash and churn or mix the reservoir 60 water. The system produces measured levels of dissolved oxygen levels in reservoir 60 water that exceed eighty percent, and on average reveal oxygenation increases of at least about 30% over uncirculated water. Additionally, because a portion of the roots of a mature plant, such as the tap root, may be immersed in the reservoir 60 water and nutrients, the present system ensures that the entire plant root system, both above and below the reservoir fill-level 62, is exposed to highly oxygenated water and nutrient source allowing plants to thrive.

An excess of decaying organic matter such as from the plant roots sluffing off matter or dying algae or other organisms, generally increases stratification and stagnation and unhealthy growing environments. Moreover, whereas the oxygenation of the water source in prior art aeroponic systems with reservoirs is limited since oxygen in such systems normally enters prior art aeroponic systems with reservoirs at the surface, through atmospheric diffusion, or alternatively, beneath the surface by using a bubbler, the present system uses a rapid recirculation of highly oxygenated reservoir 60 water and nutrients to maximize the dissolved oxygen in the reservoir 60 water which is recirculated in the system through the spray-hoop 350 and plurality of orifices 332 at least about 40 times per hour to maintain to create both highly oxygenated microbubble mist 338 and a highly oxygenated reservoir 60 water. The rapid recirculation of reservoir 60 water and nutrients through the aeroponic droplet or mist production system 30 also prevents stagnation and stratification or the reservoir 60 water and maximizes the distribution of dissolved oxygen levels in the reservoir 60.

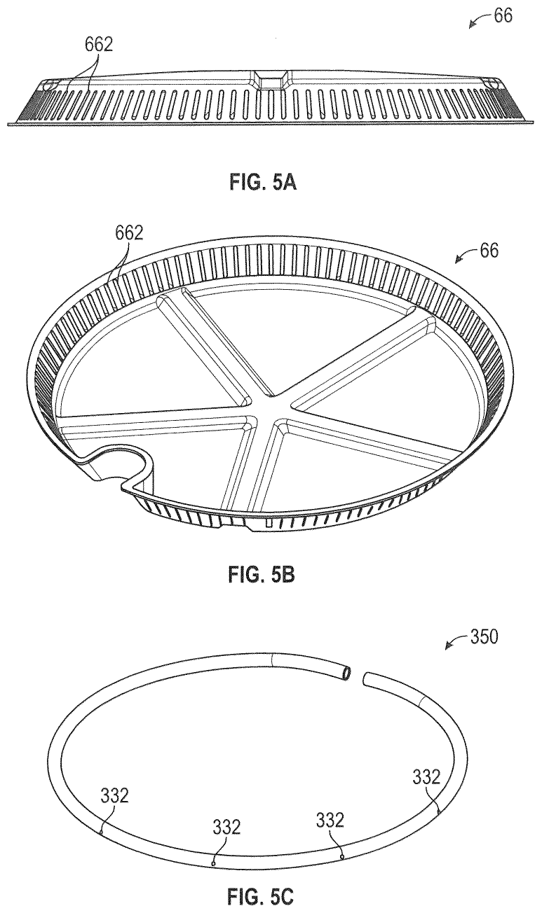

As illustrated in FIG. 6, the present system of creating an aeroponic mist and droplets creates an oxygen rich environment that promotes plant root growth and health and eliminates low-oxygen zones. The aeroponic droplet or mist production system 30 creates both a high density and volume of highly oxygenated microbubble mist 338 that remains suspended in the interior environment above the reservoir fill-level 62 and also creates or reforms larger water droplets that fall upon and splash, churn, or aerate the top layer of water in the reservoir 60. The churned or aerated surface water is pulled rapidly down into and distributed both vertically by the flow of water towards the pump inlet 322 or drain, and also laterally towards the side wall 24 throughout the reservoir 60 by a flow dispersion surface or baffle 66 that impedes the water from being pulled down directly towards the bottom of the reservoir 60 and into the drain and pump inlet 322 that is submerged in the reservoir 60 and allows a flow of water into the pump 32 for recirculation by the aeroponic droplet or mist production system 30. One or more drains or a central drain may be positioned substantially centrally in the bottom wall 22, interposed between the reservoir 60 and pump inlet 322. The at least one pump inlet 322 is preferably positioned substantially centrally beneath a flow dispersion baffle 66 oriented substantially laterally to the side wall 24 that may comprise a flow dispersion and redirection surface, plate, as in FIGS. 5A-5B, or other obstacle that is completely or substantially restrictive to water flow therethrough and that restricts the flow of liquids in the reservoir 60 from above the flow dispersion surface from flowing downward directly toward the pump inlet 322.

FIGS. 5A-5B illustrate a preferred flow dispersion surface comprised of a substantially circular flow dispersion baffle 66 with a flat unbroken interior surface and raised rim with a plurality of dispersion plate vents 662, slots, or slits in the rim to allow water to pass through the rim at the perimeter. plurality of dispersion plate vents 662 in the rim of the flow dispersion baffle 66 facilitate only mostly unimpeded flow but it is contemplated that vents or slits that may have various widths to facilitate alternate flow rates. In another embodiment (not pictured), vents may be located in the flat interior surface but would likely have a different size than the vents to purposefully direct more water flow laterally outward towards and through the perimeter vents of the flow dispersion baffle 66 and thereby encourage plant root spreading. Preferably, the flow dispersion baffle 66 extends substantially the entire inner diameter or width of the enclosure 20 but may leave a flow gap 664 between the perimeter surface of the flow dispersion baffle 66 and the side wall 24. Further, it is contemplated that the flow dispersion baffle 66 may be ridged, fluted, or otherwise textured to facilitate churn of the flow of water in the reservoir 60 being drawn into the pump inlet 322 or drain. The flow gap 664 may encircle the dispersion baffle perimeter edge 662 to maximize the lateral recirculation flow of oxygenated liquid in the reservoir 60 laterally outward in a plurality of directions relative to the central axis or center of the cylindrical enclosure 20 to facilitate maximal spreading of plant root capillaries immersed beneath or contacting the reservoir water-line 62 and root airs in a plurality of directions laterally outward from center of the enclosure 20 towards the enclosure side wall 24. In an embodiment with a cylindrically shaped enclosure 20 the flow dispersion baffle 66 is circular and positioned beneath the reservoir water-line 62 and may have a beveled edge with filtering vents that further promote or facilitate outward laterally distributed flow of recirculation water in the reservoir 60 from above the flow dispersion plate 66 and towards the pump inlet 322 or drain beneath the flow dispersion baffle 66. The flow dispersion baffle 66 may be extended from the enclosure 20 bottom wall 22 by risers or extended from the enclosure side wall 24 by brackets or may rest upon a sloped bottom wall 22 as illustrated in FIGS. 4 and 6. The flow dispersion baffle 66 also deters plant roots from being drawn into the pump inlet 322 or drain by the pump 32 recirculation suction and in mature plants may serve as a shelf-to support the mass of mature roots as the plant grows.

As illustrated by the flow arrows in FIG. 6, the flow dispersion surface directs the flow of reservoir liquid substantially laterally outward and downward along the enclosure side wall 24, thereby cooling the water by bringing it into flowing contact or proximity with the side wall 24 that are cooled with evaporator coils 222 therein, and the bottom wall 22. The recirculation flow in the reservoir 60 impedes the recirculation flow of reservoir 60 directly towards the pump inlet 322 or drain and instead laterally distributes the liquid and plant food to the plant roots throughout the reservoir 60 and thereby encourages maximal lateral spread or distribution of plant roots. In the illustrated embodiment, the flow dispersion baffle 66 is submerged in the reservoir 60 and extends substantially the entire inner diameter or width of the enclosure 20.

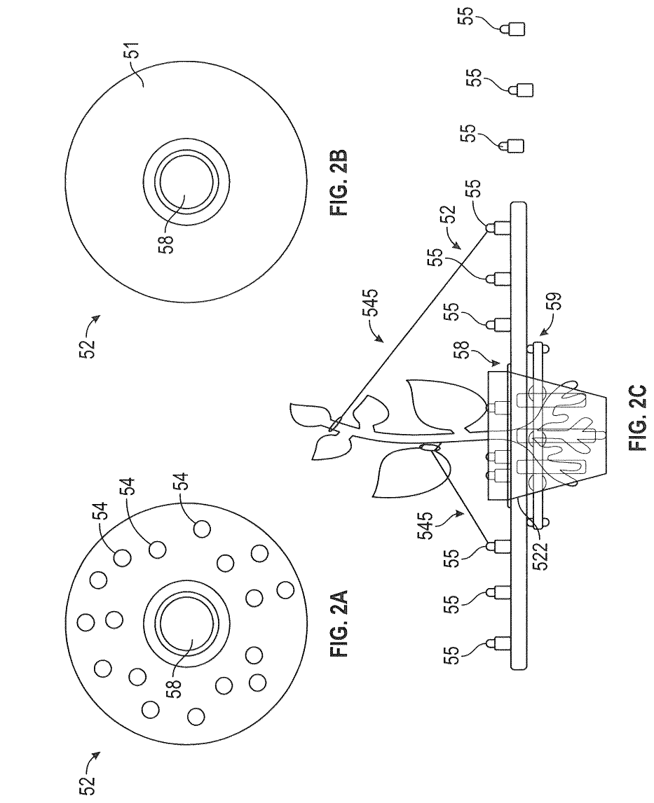

The enclosure 20 may be used in conjunction with a plant care device, as illustrated in FIGS. 2A-2C. The plant care device may be comprised of a ring and a substantially flat surface, the ring positioned substantially horizontally to and within the surface, the ring functionally coupled to the substantially flat surface by an annular rotation device that enables annular relative rotation between the ring and the substantially flat surface; the substantially flat surface configured to receive a plurality of tie-down-anchors. In use, a plant with roots and a plurality of stems is receivable in a net pot, the roots and a portion of the net pot receivable through the ring, and the plurality of stems are respectively securable to the tie-down anchors. The annular rotation device may be selected from a Lazy-Susan, a carousel, and a swivel turntable, or other equivalent devices that enable relative annular rotation between adjacent structures. The substantially flat surface may include or be comprised of sheet, layer, or portions of magnetic material and configured to receive a plurality of tie-down-anchors that are comprised of a ferromagnetic material. Alternatively, the substantially flat surface may be comprised of magnetic material and the plurality of tie-down-anchors may be comprised of ferromagnetic material.

With reference to the illustrated embodiment, the trimming table is comprised of a rotatable tabletop 52 and a plurality of removably securable tie-down anchors 55 that are securable around the tabletop 52 and onto which plant stems may be removably secured. The removably securable tie-down anchors 55 may be secured to the tabletop 52 by a variety of components or structures that enable the removably securable tie-down anchors 55 to be removably secured to the tabletop 52. In a first preferred embodiment in FIG. 2B, the tabletop 52 includes a sheet or layer of a ferromagnetic material 51 that inherently, due to its physical properties, is attracted to one or more magnetic fields, such as from permanent magnet material, and magnetic material may be incorporated into the tie-down anchors 55, or alternatively a sheet or layer of permanent magnet material 51 that is magnetically attracted to tie-downs anchors 55 including a sufficient ferromagnetic metal content and may be used. In a second embodiment in FIG. 2A, the an inherently magnetically attractive material such as ferromagnetic metal surfaces 54 are distributed on the tabletop 52 and the plurality of tie-downs 55 are comprised of a sufficient permanent magnet material that enables the tie-downs 55 to be removably attachable thereto (or vice versa), each of which may be removably securable to one of the plurality of metal surfaces 54 on the table top and wherein a plant stem may be secured by a line or metallic wire 545 such as copper, between a plant stem and one of the plurality of magnets 55 that is secured to one of the plurality of metal surfaces 54. Alternative removably attachable structures such as hook-and-loop fasteners or rings and hooks may also be employed as equivalents. The tabletop 52 further includes a tabletop pot aperture 58 that is configured to receive a net pot 522 diameter and restrict the lip or other larger diameter of the net pot so as to suspend or support the net pot as substantially received within the tabletop pot aperture 58.

In a preferred embodiment, the tabletop 52 is configured or configurable for rotation of the tabletop 52 and tabletop pot aperture 58 relative to a second surface or structure that supports the tabletop 52, and that is preferably, but not necessarily, fixed relative to the user. In one preferred embodiment, the tabletop 52 bottom surface rests upon, rotatable mechanism such as a rotatable ring 59, (or turntable, Lazy-Susan, or carousel with inner aperture adapted to receive a net pot), that is interposed between the tabletop 52 bottom surface and the second surface (not shown), wherein the rotatable ring 59 enables relative rotation between the tabletop 52 bottom surface and the second surface or structure. For the purposes of this description, a turntable, Lazy-Susan, or carousel includes all designs comprising rotating adjacent surfaces that enable relative rotational movement between two horizontal surfaces. In another embodiment, the tabletop 52 is comprised of at least an inner and outer rings with bearings or a slippery surface interposed between the inner and outer rings so that the inner ring is configured for rotation relative to the inner ring. Moreover, the inner ring may have stand-offs so that it the inner ring may support the tabletop 52 upon a fixed flat surface and allow the inner and outer rings to rotate to facilitate trimming of a plant in the tabletop 52. The tabletop 52 is capable of 360-degree rotation and in use, the tabletop 52 may be rotated in either direction for 360 degrees or further. The rotatable mechanism facilitates rotation of the tabletop 52 and plant received within the tabletop pot aperture 58 to rotate relative to the second surface or structure or a user fixed relative to the second surface or structure and enables the user to rotate the tabletop 52 and plant positioned therein and enable the users' positionally fixed access to all sides of the plant leaves and stems while attending to the plant and during an activity such as trimming of the plant leaves and stems. In an alternate embodiment, the tabletop 52 further comprises an inner diameter and outer diameter table portions that are rotatably related to each other such as by wheels, rollers, bearings, slippery surfaces between the inner and outer portions, or any equivalent device, design, that enables relative rotation between the inner and outer portions.

While various embodiments have been described above, it should be understood that the embodiments have been presented by way of example only, and not limitation. Thus, the breadth and scope of a preferred embodiment should not be limited by any of the above-described exemplary embodiments but should be defined only in accordance with the following claims and their equivalents.

1. A method of creating a plant care environment, comprising:
providing an enclosure, the enclosure comprised of a top wall, a side wall, and a bottom wall that collectively surround a tubular shaped root-growth zone, the top wall with a pot aperture above the tubular shaped root-growth zone,
providing a reservoir within the enclosure, the reservoir fillable into the tubular shaped root-growth zone;
draining water from the reservoir from along the side wall to a drain positioned centrally beneath the reservoir;
pumping water from the reservoir into a spray-hoop, the spray-hoop with an outer perimeter with plurality of orifices spaced substantially equidistantly around the outer perimeter, the spray-hoop substantially encircles the tubular shaped root-growth zone with the outer perimeter within about six inches from the side wall;
outputting a plurality of high kinetic energy liquid streams from the plurality of orifices that impact against the side wall and shatter into a range of water mist and droplet sizes that includes a micrometer and smaller sized droplet diameters and larger water droplet diameters, the micrometer and smaller sized droplet diameters temporarily suspended in the enclosure longer relative to larger water droplet diameters, the range of water mist and droplet sizes scattered by the impact substantially evenly and around within the enclosure to land on plant roots, the side wall, and the reservoir; and
recirculating the water in the reservoir through the pump at a rate sufficient to maintain a target dissolved oxygen level in the reservoir and enable the high kinetic energy liquid streams sufficient velocity to cause the shatter of the plurality of high kinetic energy liquid streams.

2. The method in claim 1 wherein,
draining comprises draining though a flow dispersion baffle, the flow dispersion baffle comprised of a dispersion baffle interior surface and a dispersion baffle perimeter surface that extends from the dispersion baffle inner surface, the drain beneath the dispersion baffle interior surface, a plurality of dispersion baffle vents distributed around the dispersion baffle perimeter surface.

3. The method in claim 1 wherein,
the spray-hoop extends laterally around and adjacent to the side wall, the plurality of orifices configured to direct the high kinetic energy liquid streams substantially perpendicularly to the side wall.

4. The method in claim 1 wherein,
draining further comprises directing the water in the reservoir to the side wall by a submerged surface in the reservoir and positioned substantially laterally in the enclosure.

5. The method in claim 4 wherein,
the enclosure has an inner diameter, and the submerged surface extends substantially the entire inner diameter of the enclosure with a flow gap between the surface and the side wall.

6. The method in claim 1 wherein,
the reservoir includes less than 15 gallons of water and the recirculation rate sufficient to maintain a target dissolved oxygen level in the reservoir and enable shattering of the plurality of high kinetic energy liquid streams exceeds 40 gallons per hour.

7. The method in claim 1 wherein,
a plant is grown in the pot aperture and a first portion of roots from the plant are suspended above the reservoir and a second portion of roots from the plant are submerged in the reservoir.

8. A method of creating a plant care environment in an enclosure,
the enclosure comprised of
a top wall, a side wall, and a bottom wall, that collectively surround a tubular shaped root-growth zone, the top wall with a pot aperture above the tubular shaped root-growth zone,
a reservoir within the enclosure, the reservoir fillable into the tubular shaped root-growth zone,
a dispersion baffle comprised of a dispersion baffle inner surface and a dispersion baffle perimeter surface, the dispersion baffle substantially submerged in the tubular shaped root-growth zone, the dispersion baffle inner surface substantially unvented, a plurality of dispersion baffle vents distributed substantially equally around the dispersion baffle perimeter surface,
a pump in fluid communication with a drain and a spray-hoop, the drain positioned substantially centrally under the dispersion baffle inner surface beneath the reservoir, the spray-hoop positioned adjacent to the side wall to encircle the tubular shaped root-growth zone above the reservoir, the spray-hoop with a plurality of orifices spaced substantially equidistantly around an outside perimeter of the spray-hoop and aimed at the side wall,
the method comprising:
pumping water from the reservoir through the plurality of orifices to create a plurality of water streams each at at least six pounds per square inch;
shattering each of the plurality of water streams against the side wall to create a range of water mist and range of droplet sizes encircling the tubular shaped root-growth zone, the range of water mist and droplet sizes includes a micrometer and smaller sized droplet diameters and larger water droplet diameters, the micrometer and smaller sized droplet diameters temporarily suspended in the tubular shaped root-growth zone longer relative to larger water droplet diameters, the range of water mist and droplet sizes scattered by the impact substantially evenly and around within the tubular shaped root-growth zone; and
draining water from the reservoir substantially laterally towards the side wall through the plurality of dispersion baffle vents; and
recirculating the water from the reservoir through the plurality of orifices.

9. The method in claim 8 wherein,
the pump provides at least about 3 ft of head pressure to the plurality of orifices.

10. The method in claim 8 wherein,
the spray-hoop has at least four orifices distributed substantially equally around the outside perimeter of the spray-hoop.

11. The method in claim 8 wherein,
evaporator coils are embedded in the side wall and the method further comprises cooling the tubular shaped root-growth zone to a first temperature and ramping the temperature in the tubular shaped root-growth zone to a second temperature over a time period.

12. The method in claim 11 wherein,
ramping further comprises holding the temperature in the enclosure at one or each of a plurality of temperature ranges based on nutrient absorption efficiency target temperatures.

13. The method in claim 11 wherein,
ramping comprises cooling the tubular shaped root-growth zone to a first temperature and allowing the tubular shaped root-growth zone to warm to second temperature over the time period.

14. The method in claim 8 wherein,
recirculating comprises recirculating the water in the reservoir through the plurality of orifices at least about 40 times per hour.

15. The method in claim 8 wherein,
the dispersion baffle perimeter surface and the side wall are separated by a gap and draining comprises draining water through the gap into the plurality of dispersion baffle vents.

16. The method in claim 8 wherein,
the enclosure has a volume of between 8 and 15 cubic ft, and
the method further comprises adjusting the barometric pressure in the enclosure by adjusting the water volume in the enclosure.

17. The method in claim 8 wherein,
the top wall is coupled to the side wall by lift arms that extend upward from the side wall,
the method further comprises extending the lift arms to raise the top wall above the side wall.

18. The method in claim 8 wherein,
a rotatable tabletop is positioned above the top wall, the tabletop comprised of a sheet of permanent magnet material that surrounds the pot aperture, and the method comprises, rotating the tabletop to care for a plant in the pot aperture.

19. A method of creating a plant care environment in an enclosure,
the enclosure comprised of
a top wall, a side wall, and a bottom wall, that collectively surround a tubular shaped root-growth zone, the top wall with a pot aperture above the tubular shaped root-growth zone,
evaporator coils and insulation sandwiched between an outside side wall and an inside side wall to cool the tubular shaped root-growth zone,
a reservoir within the enclosure, the reservoir fillable into the tubular shaped root-growth zone,
a dispersion baffle comprised of a dispersion baffle inner surface and a dispersion baffle perimeter surface, the dispersion baffle substantially submerged in the tubular shaped root-growth zone, the dispersion baffle inner surface substantially unvented, a plurality of dispersion baffle vents distributed substantially equally around the dispersion baffle perimeter surface,
a pump in fluid communication with a drain and a spray-hoop, the drain positioned substantially centrally under the dispersion baffle inner surface beneath the reservoir, the spray-hoop positioned adjacent to the side wall to encircle the tubular shaped root-growth zone above the reservoir, the spray-hoop with a plurality of orifices spaced substantially equidistantly around an outside perimeter of the spray-hoop and aimed at the side wall,
the method comprising:
pumping water from the reservoir through the plurality of orifices to create a plurality of water streams each at at least six pounds per square inch;
shattering each of the plurality of water streams equidistantly around and against the side wall to create a range of water mist and droplet sizes encircling the tubular shaped root-growth zone, the range of water mist and droplet sizes includes a micrometer and smaller sized droplet diameters and larger water droplet diameters, the micrometer and smaller sized droplet diameters temporarily suspended in the tubular shaped root-growth zone longer relative to larger water droplet diameters, the range of water mist and droplet sizes scattered by the impact substantially evenly and around within the tubular shaped root-growth zone; and
draining water from the reservoir substantially laterally towards the side wall through the plurality of dispersion baffle vents; and
recirculating the water from the reservoir through the plurality of orifices.

20. The method in claim 8 wherein,
the evaporator coils in the side wall extend vertically from positions laterally across from the reservoir to positions laterally across from the plurality of orifices.
